(19) United States
(12) Patent Application Publication
(10) Pub. No.: US 2015/0160864 A1
(43) Pub. Date: Jun. 11, 2015

(54) SYSTEMS AND METHODS FOR HIGH AVAILABILITY IN MULTI-NODE STORAGE NETWORKS

(71) Applicant: NetApp, Inc., Sunnyvale, CA (US)

(72) Inventors: Ameya Prakash Usgaonkar, Bangalor (IN); Siddhartha Nandi, Bangalor (IN)

(73) Assignee: NetApp, Inc., Sunnyvale, CA (US)

(21) Appl. No.: 14/101,016

(22) Filed: Dec. 9, 2013

(51) Int. Cl. G06F 3/06; G06F 15/173

(52) U.S. Cl. CPC G06F 3/065; G06F 15/17331; G06F 3/0611; G06F 3/067

(57) ABSTRACT

Systems and methods for increasing high availability of data in a multi-node storage network are provided. Aspects may include allocating data and mirrored data associated with nodes in the storage network to storage units associated with the nodes. Upon identifying additional nodes added to the storage network, data and mirrored data associated with the nodes may be dynamically reallocated to the storage units. Systems and methods for high availability takeover in a high availability multi-node storage network are also provided. Aspects may include detecting a fault associated with a node in the storage network, and initiating a takeover routine in response to detecting the fault. The takeover routine may be implemented to reallocate data and mirrored data associated with the nodes in the storage network among the operable nodes and associated storage units.

### TECHNICAL FIELD

The subject matter relates generally to storage networks and, more particularly, to high availability in multi-node storage networks.

### BACKGROUND

The creation and storage of digitized data has proliferated in recent years. Accordingly, techniques and mechanisms that facilitate efficient and cost effective storage of large amounts of digital data are common today. For example, a cluster network environment of nodes may be implemented as a data storage system to facilitate the creation, storage, retrieval, and/or processing of digital data. Such a data storage system may be implemented using a variety of storage architectures, such as a network-attached storage (NAS) environment, a storage area network (SAN), a direct-attached storage environment, and combinations thereof. The foregoing data storage systems may comprise one or more data storage entities configured to store digital data within data volumes.

In order to provide resiliency and fault tolerance, the availability of data associated with a node in a cluster must be extended beyond the storage unit associated with the node. Conventional systems have attempted to extend data availability, but exhibit significant drawbacks that make the solutions unfavorable to consumers. For example, one conventional system provides increased data availability by employing specialized hardware to mirror data to multiple locations. However, this is costly because it does not efficiently utilize hardware currently available in the system, and instead requires additional specialized hardware requirements to extend data availability. Further, mirroring in multiple locations is also difficult when handling large storage volumes. Another conventional system attempts to remove the additional specialized hardware to provide increased data availability by physically connecting the nodes in a cluster. However, although cheaper than its predecessor, this is implicitly constrained from scaling beyond a fixed number of nodes in the cluster, which is typically four.

To avoid the aforementioned drawbacks associated with hardware solutions, another conventional system attempts to provide increased data availability by using software techniques, such as Reed-Solomon codes or Erasure codes, to scatter data across different nodes. However, the codes, which were originally designed primarily for IP networks, are very computation intensive and incur significant overhead, which results in lower throughput until the data is redistributed again—another unfavorable drawback.

### Overview

In aspects of the disclosure, systems and methods for increasing high availability of data in a multi-node storage network may be operable to allocate to a first storage unit associated with a first node first data associated with the first node and mirrored second data associated a second node. The systems and methods may also be operable to allocate to a second storage unit associated with the second node second data associated with the second node and mirrored first data associated with the first node. In operation according to aspects of the disclosure, the aforementioned allocation may balance the data and mirrored data associated the first and second nodes. Systems and methods may be further operable to utilize and/or identify a third node associated with a third storage unit which is added to the multi-node storage network. The systems and methods may be operable to dynamically balance and reallocate the data and mirrored data associated with the first node, second node, and third node to the first storage unit, second storage unit, and third storage unit. Other features and modifications can be added and made to the systems and methods described herein without departing from the scope of the disclosure.

In aspects of the disclosure, systems and methods for high availability takeover in a multi-node storage network with increased high availability of data may be operable to detect a fault associated with a first node in the multi-node storage network that includes at least the first node, a second node, and a third node. In operation according to aspects of the disclosure, the systems and methods may also be operable to initiate a takeover routine by the second node in response to detecting the fault. The systems and methods may be further operable to implement the takeover routine to reallocate data and mirrored data associated with the first node, second node, and third node to a second storage unit associated with the second node and a third storage unit associated with the third node.

The foregoing has outlined rather broadly the features and technical advantages of the exemplary aspects in order that the detailed description of the invention that follows may be better understood. Additional features and advantages will be described hereinafter which foam the subject of the claims. It should be appreciated by those skilled in the art that the conception and specific aspect disclosed may be readily utilized as a basis for modifying or designing other structures for carrying out the same purposes described herein. It should also be realized by those skilled in the art that such equivalent constructions do not depart from the spirit and scope of the disclosure as set forth in the appended claims. The novel features which are believed to be characteristic of aspects of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the claims.

### BRIEF DESCRIPTION OF THE DRAWINGS

For a more complete understanding of the subject matter, reference is now made to the following descriptions taken in conjunction with the accompanying drawing, in which:

FIG. 1 is a block diagram illustrating a storage system in accordance with an aspect of the disclosure;

FIG. 2 is a block diagram illustrating high availability in a storage network in accordance with an aspect of the disclosure;

FIG. 3 is a block diagram illustrating the addition of a node to a storage network in accordance with an aspect of the disclosure;

FIG. 4 is a block diagram illustrating dynamic reallocation of data in a storage network to provide high availability in accordance with an aspect of the disclosure;

FIG. 5 is a block diagram illustrating a faulty node in a high availability storage network in accordance with an aspect of the disclosure;

FIG. 6 is a block diagram illustrating a takeover routine and reallocation of data in the storage network to provide high availability in accordance with an aspect of the disclosure;

FIG. 7 is a schematic flow chart diagram illustrating an example process flow for a method in accordance with an aspect of the disclosure; and

FIG. 8 is another schematic flow chart diagram illustrating an example process flow for a method in accordance with an aspect of the disclosure.

### DETAILED DESCRIPTION

Aspects disclosed herein may extend data availability beyond two-node high availability pairs without employing specialized hardware, and without stressing the processing resources of a node in the cluster, thereby avoiding the incurrence of additional expenses and significant overhead. For example, aspects of the disclosure may scale data availability proportionately as nodes are added to or removed from the cluster. In addition, aspects of the disclosure may also dynamically relocate a high availability relationship to any node in the cluster with minimal disruption to other nodes in the cluster, which allows storage units to move transparently across nodes in the cluster to provide automatic load balancing. Other aspects of the disclosure may provide both simplified storage management and automatic load balancing without user intervention.

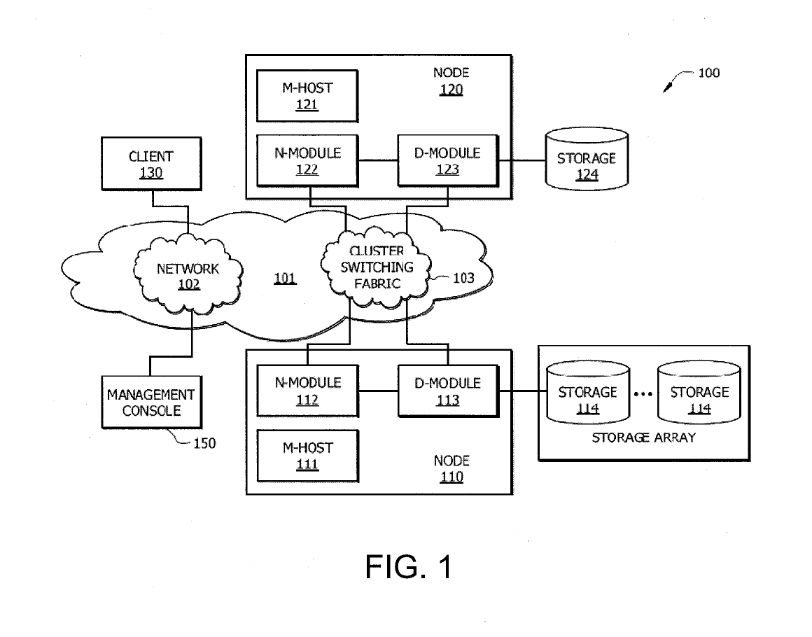

FIG. 1 provides a block diagram of a storage system 100 in accordance with an aspect of the disclosure. System 100 includes a storage cluster having multiple nodes 110 and 120 which are adapted to communicate with each other and any additional node of the cluster. Nodes 110 and 120 are configured to provide access to data stored on a set of storage devices (shown as storage devices 114 and 124) constituting storage of system 100. Storage services may be provided by such nodes implementing various functional components that cooperate to provide a distributed storage system architecture of system 100. Additionally, one or more storage devices, such as storage array 114, may act as a central repository for storage system 100. It is appreciated that aspects of the disclosure may have any number of edge nodes such as multiple nodes 110 and/or 120. Further, multiple storage arrays 114 may be provided at the multiple nodes 110 and/or 120 which provide resources for mirroring a primary storage data set.

Illustratively, nodes (e.g. network-connected devices 110 and 120) may be organized as one or more network elements (N-modules 112 and 122) and/or storage elements (D-modules 113 and 123) and a management element (M-host 111 and 121). N-modules may include functionality to enable nodes to connect to one or more clients (e.g. network-connected client device 130) over computer network 101, while D-modules may connect to storage devices (e.g. as may implement a storage array). M-hosts may provide cluster communication services between nodes for generating information sharing operations and for presenting a distributed file system image for system 100. Functionality for enabling each node of a cluster to receive name and object data, receive data to be cached, and to communicate with any other node of the cluster may be provided by M-hosts adapted according to aspects of the disclosure.

It should be appreciated that network 101 may comprise various forms, and even separate portions, of network infrastructure. For example, network-connected devices 110 and 120 may be interconnected by cluster switching fabric 103 while network-connected devices 110 and 120 may be interconnected to network-connected client device 130 by a more general data network 102 (e.g. the Internet, a LAN, a WAN, etc.).

It should also be noted that while there is shown an equal number of N- and D-modules constituting illustrated aspects of nodes, there may be a different number and/or type of functional components embodying nodes. For example, there may be multiple N-modules and/or D-modules interconnected in system 100 that do not reflect a one-to-one correspondence between the modules of network-connected devices 110 and 120. Accordingly, the description of network-connected devices 110 and 120 comprising one N- and one D-module should be taken as illustrative only and it will be understood that the novel technique is not limited to the illustrative aspect discussed herein.

Network-connected client device 130 may be a general-purpose computer configured to interact with network-connected devices 110 and 120 in accordance with a client/server model of information delivery. To that end, network-connected client device 130 may request the services of network-connected devices 110 and 120 by submitting a read or write request to the cluster node. In response to the request, the node may return the results of the requested services by exchanging information packets over network 101. Client device 130 may submit access requests by issuing packets using application-layer access protocols, such as the Common Internet File System (CIFS) protocol, Network File System (NFS) protocol, Small Computer Systems Interface (SCSI) protocol encapsulated over TCP (iSCSI), SCSI encapsulated over Fibre Channel (FCP), and SCSI encapsulated over Fibre Channel over Ethernet (FCoE) for instance.

System 100 may further include a management console 150 for providing management services for the overall cluster. Management console 150 may, for instance, communicate with nodes 110 and 120 across network 101 to request operations to be performed and to request information (e.g. node configurations, operating metrics) or provide information to the nodes. In addition, management console 150 may be configured to receive inputs from and provide outputs to a user of system 100 (e.g. storage administrator) thereby operating as a centralized management interface between the administrator and system 100. In the illustrative aspect, management console 150 may be networked to network-connected devices 110-130, although other aspects of the disclosure may implement management console 150 as a functional component of a node or any other processing system connected to or constituting system 100.

Management console 150 may also include processing capabilities and code which is configured to control system 100 in order to allow for management of tasks within network 100. For example, management console 150 may be utilized to configure/assign various nodes to function with specific clients, storage volumes, etc. Further, management console 150 may configure a plurality of nodes to function as a primary storage resource for one or more clients and a different plurality of nodes to function as secondary resources, e.g. as disaster recovery or high availability storage resources, for the one or more clients.

In a distributed architecture, network-connected client device 130 may submit an access request to a node for data stored at a remote node. As an example, an access request from network-connected client device 130 may be sent to network-connected device 120 which may target a storage object (e.g. volume) on network-connected device 110 in storage 114. This access request may be directed through network-connected device 120 due to its proximity (e.g. it is closer to the edge than a device such as network-connected device 110) or ability to communicate more efficiently with client device 130. To accelerate servicing of the access request and optimize cluster performance, network-connected device 120 may prefetch and cache the requested volume in local memory or in storage 124.

As can be appreciated from the foregoing, in order to operate as a cluster (e.g. the aforementioned data storage system), network-connected devices 110-130 may communicate with each other. Such communication may include various forms of communication (e.g. point-to-point or unicast communication, multicast communication). Such communication may be implemented using one or more protocols such as CIFS protocol, NFS, iSCSI, FCP, FCoE, and the like. Accordingly, to effectively cooperate to provide desired operation as a logical entity, each node of a cluster is provided with the capability to communicate with any and all other nodes of the cluster according to aspects of the disclosure.

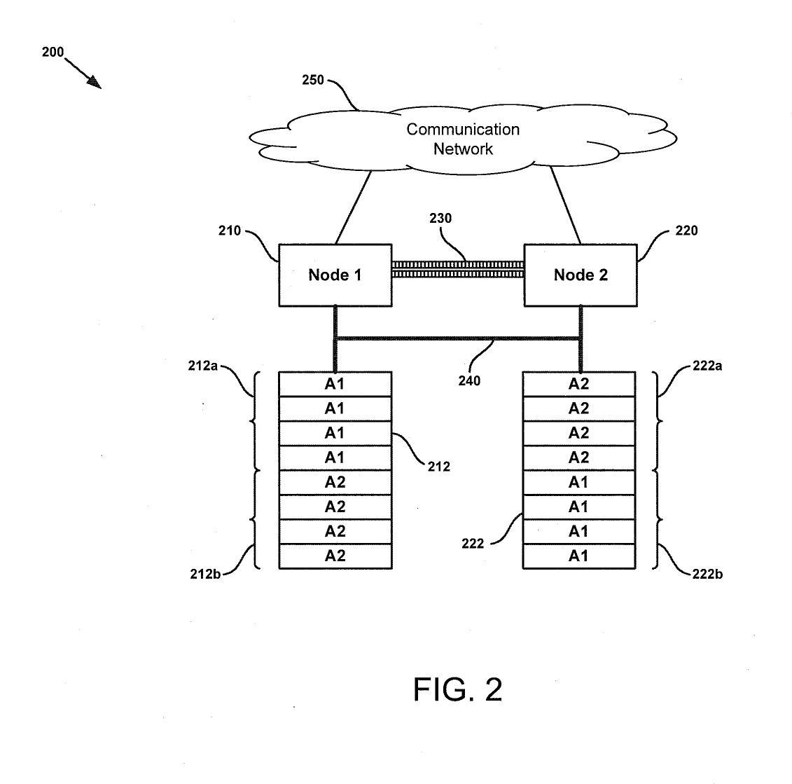

FIG. 2 illustrates a block diagram of high availability storage system 200 in accordance with an aspect of the disclosure. Storage system 200 includes two nodes, node 210 and node 220. According to another aspect, a storage system may include one or more nodes depending on the application, the amount of data to be stored, and the like. Each node in a storage system may, in one aspect of the disclosure, be associated with a storage unit. For example, node 210 may be associated with storage unit 212 and node 220 may be associated with storage unit 222. Referring back to FIG. 1, storage system 200 may correspond to storage system 100, nodes 210, 220 may correspond to nodes 110, 120, respectively, and storage units 212, 222 may correspond to storage devices 114, 124, respectively.

According to an aspect of the disclosure, a storage unit may be partitioned into two or more storage container portions. For example, a first storage container portion of the storage unit may store local data, which may be data associated with the node to which the storage unit is associated. A second storage container portion of the storage unit may store partner data, which may be mirrored data associated with another node in a storage system. For example, storage unit 212 may be partitioned into storage container portion 212a to store local data associated with node 210 and storage container portion 212b to store mirrored data associated with node 220. Similarly, storage unit 222 may be partitioned into storage container portion 222a to store local data associated with node 220 and storage container portion 222b to store mirrored data associated with node 210. In other aspects of the disclosure, storage units may be partitioned into one or more storage container portions, and each storage container portion may store local data, mirrored data, or a combination of local and mirrored data associated with one or more nodes in the storage system.

In an aspect of the disclosure, one or more nodes in a high availability storage system may be coupled to each other via a high availability interconnect. For example, node 210 and node 220 of high availability storage system 200 may be coupled to each other via high availability interconnect 230. The high availability interconnect 230 may be a cable bus that includes adapters, cables, and the like. In some aspects of the disclosure, one or more nodes of a storage system may contain one or more controllers, and the one or more controllers of the one or more nodes may connect to the high availability interconnect to couple the one or more nodes to each other. In other aspects of the disclosure, the high availability interconnect may be an internal interconnect with no external cabling.

In some aspects, the nodes in a storage system may also be coupled to one or more storage units in the storage system via a data connection, which may also be a bus. For example, node 210 and node 220 of high availability storage system 200 may each connect to data connection 240, which allows node 210 and node 220 to access and control storage unit 212 and storage unit 222. For additional resiliency, the data connection may include redundant data connections. As an example, and not limitation, node 210 may access and control storage unit 212 and storage unit 222 via one or more redundant data connections included within the data connection 240. Likewise, node 220 may access and control storage unit 212 and storage unit 222 via one or more redundant data connections included within the data connection 240.

According to an aspect of the disclosure, one or more nodes in a storage system may communicate with each other via a communication network. For example, node 210 and node 220 may communicate with each other via communication network 250. Communication network 250 may include any type of network such as a cluster switching fabric, the Internet, WiFi, mobile communications networks such as GSM, CDMA, 3G/4G, WiMax, LTE and the like. In addition, communication network 250 may comprise a combination of network types working collectively.

In the aspect of the disclosure illustrated in FIG. 2, high availability of storage system 200 may be increased by allocating to storage unit 212 local data associated with node 210 and mirrored data associated with node 220, and by allocating to storage unit 222 local data associated with node 220 and mirrored data associated with node 210. For example, data associated with node 210, such as data A1, may be allocated to storage container portion 212a, and data associated with node 220, such as data A2, may be allocated to storage container portion 212b. In some aspects of the disclosure, data A2 in storage container portion 212b may correspond to the mirrored data associated with node 220. Similarly, data A2 may be allocated to storage container portion 222a, and data A1 may be allocated to storage container portion 222b, where data A1 in storage container portion 222b may correspond to the mirrored data associated with node 210. In some aspects of the disclosure, data associated with a node may be mirrored over to storage units associated with other nodes via the high availability interconnect. According to an aspect of the disclosure, allocating the data and mirrored data associated with node 210 and node 220 as discussed above may balance the data and mirrored data associated with node 210 and node 220 among storage unit 212 and storage unit 222. As a result, the high availability of the data in storage network 200 may be increased.

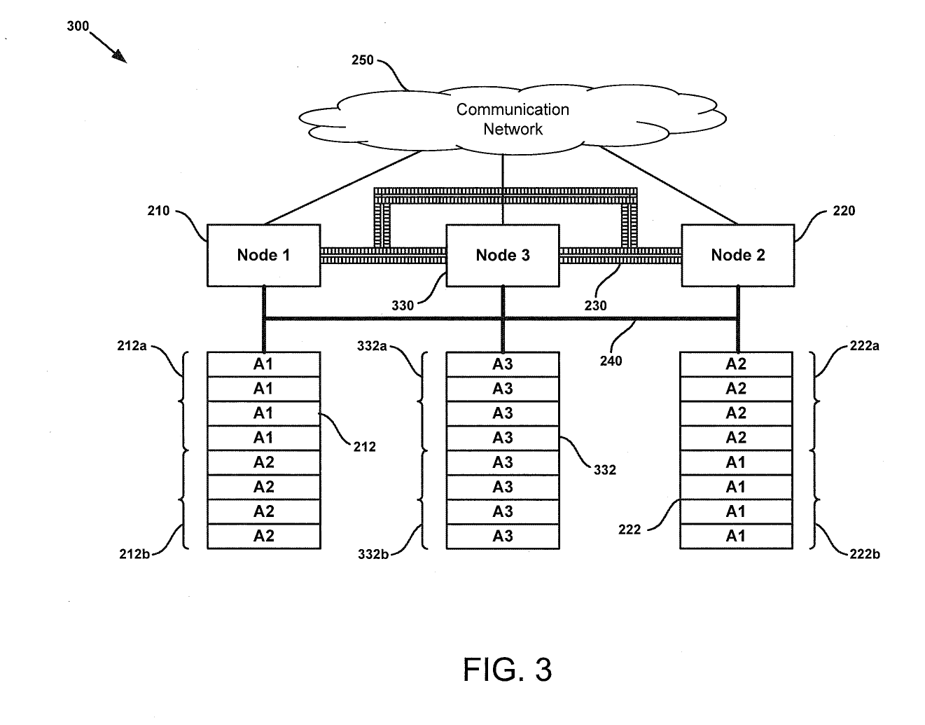

FIG. 3 is a block diagram illustrating the addition of a node to a storage network in accordance with an aspect of the disclosure. Therefore, the high availability storage system 300 of FIG. 3 may include storage system 200 of FIG. 2 with the addition of node 330, storage unit 332 associated with node 330, and additional cabling to interconnect node 330 with the other components in the storage network, such as node 210, node 220, storage unit 212, and storage unit 222. As is illustrated in FIG. 3, upon being added to storage system 300, the storage unit 332 associated with node 330 may store data associated with node 330, such as data A3, but may not initially store mirrored data or have its data mirrored to another storage unit. To extend fault tolerance to tolerate a fault in node 330 and still be able to provide data services including data associated with node 330 stored in storage unit 332, high availability may be extended to include node 330 and the data and components associated with node 330, such as storage unit 332. In some aspects of the disclosure, data associated with node 210, node 220, and node 330 may be reallocated to extend high availability beyond node 210 and node 220, and to incorporate node 330. According to an aspect of the disclosure, extending high availability to nodes added to a storage system may include identifying the additional nodes added to the system along with any additional storage units associated with the added nodes. For example, extending high availability in storage system 300 may include identifying node 330, associated with storage unit 332, added to the multi-node storage network 300 that includes at least node 210 and node 220.

In one aspect of the disclosure, identifying node 330 may include receiving, by at least one of node 210 and node 220, a notification from node 330 indicating its addition to the storage network 300. For example, node 330 may broadcast its intent to join storage system 300 over communication network 250. In some aspects of the disclosure, at least one of node 210 and node 220 may receive the broadcast, after which at least one of node 210 and node 220 may send a response to node 330. According to one aspect of the disclosure, the nodes in a storage system may receive the broadcast from an added node at substantially the same time, and the nodes in the storage system may respond to the added node immediately upon receiving the broadcast. Although node 330 may receive replies from node 210 and node 220, node 330 may select one of node 210 and node 220 as its neighbor to establish a mirror relationship. In general, because nodes may be connected via a switched storage network, nodes in a storage system may be considered neighbors and equidistant to and added node. According to an aspect of the disclosure, the node added to a storage system may send a notification to one of the responding nodes currently in the storage system to indicate its intent to establish a mirror relationship with the chosen node. For example, in the aspect of the disclosure illustrated in FIG. 3, node 330 may select node 220 as the neighbor with which it will establish a mirror relationship and node 220 may confirm its selection as the neighbor.

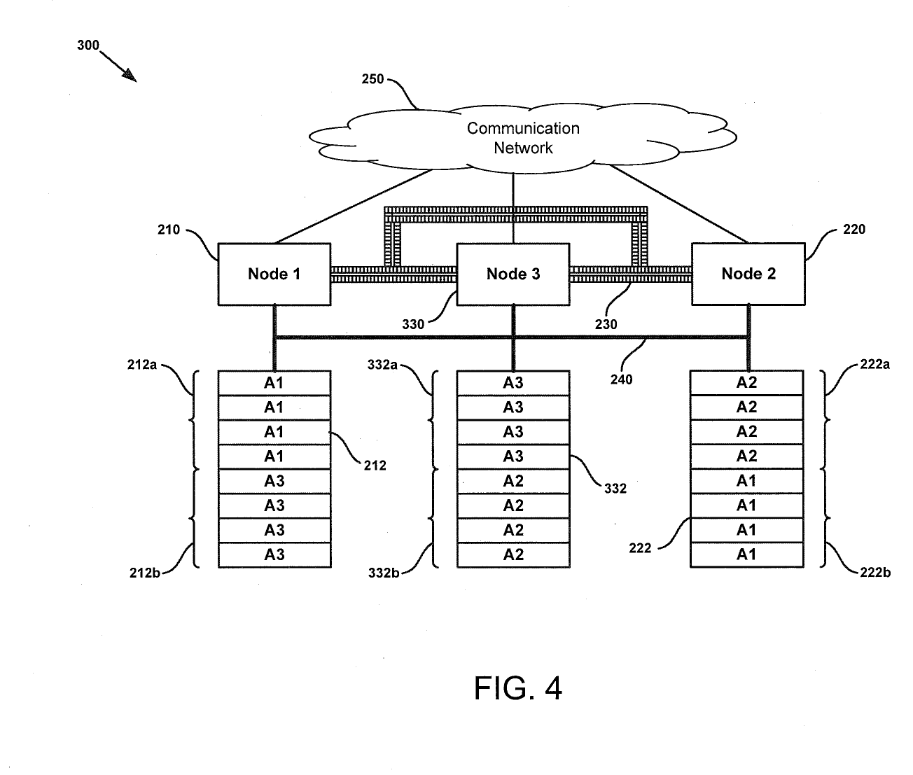

According to an aspect of the disclosure, after a neighbor relationship is established for a node added to a storage system, mirrored data associated with at least one of the nodes in the storage system may be dynamically reallocated to one or more storage units in the storage system to rebalance the data and/or mirrored data associated with at least one of the nodes in the storage system among the one or more storage units. For example, FIG. 4 is a block diagram illustrating dynamic reallocation of data in a storage network 300 to provide high availability in accordance with an aspect of the disclosure. According to the aspect of the disclosure of FIG. 4, node 220 has agreed to set up a mirror relationship with node 330. As a result, the data and/or mirrored data associated with node 210, node 220, and node 330 may be dynamically reallocated to storage unit 212, storage unit 222, and storage unit 232 to rebalance the data and/or mirrored data associated with node 210, node 220, and node 330 among storage unit 212, storage unit 222, and storage unit 332. To support high availability, storage unit 332 may be partitioned into storage container portion 332a to store local data associated with node 330 and storage container portion 332b to store mirrored data associated with node 220, the node with which a neighbor relationship was established for node 330.

In some aspects of the disclosure, dynamically reallocating the data and mirrored data associated with node 210, node 220, and node 330 may include allocating to storage unit 332 data A3 and mirrored data A2, allocating to storage unit 212 data A1 and mirrored data A3, and allocating to storage unit 222 data A2 and mirrored data A1. For example, as illustrated in FIG. 4, data A3 may be allocated to storage container portion 332a, mirrored data A2 may be allocated to storage container portion 332b, data A1 may be allocated to storage container 212a, mirrored data A3 may be allocated to storage container portion 212b, data A2 may be allocated to storage container portion 222a, and mirrored data A1 may be allocated to storage container portion 222b.

According to an aspect of the disclosure, the dynamic reallocation of data and mirrored data in the storage system to provide increased high availability may be initiated by the node added to the storage system. For example, node 330 may instruct node 220 to dynamically reallocate its mirror from storage unit 212 to storage unit 332. Upon receiving the instruction, node 220 may confirm its high availability mirroring relationship with node 330 and notify node 210. When a node is instructed to reallocate the mirrored data stored in its associated storage unit, the node may respond to the node that initiated the reallocation of data and mirrored data to notify the initiating node that it has an available storage container portion in which mirrored data associated with the added node may be stored. For example, node 210 may respond to node 330 to notify node 330 that mirrored data A2 that was previously stored in its associated storage unit 212 has been reallocated elsewhere, thereby freeing up the storage container portion 212b in which the mirrored data A2 was previously stored. Node 330 may respond by allocating its mirrored data A3 to the storage container portion 212b. With the mirrored data A3 allocated to storage container portion 212b, the data and mirrored data associated with node 210, node 220, and node 330 may be balanced among storage unit 212, storage unit 222, and storage unit 332, as shown in FIG. 4, thereby extending high availability and fault tolerance to all the nodes 210, 220, and 330 in storage system 300.

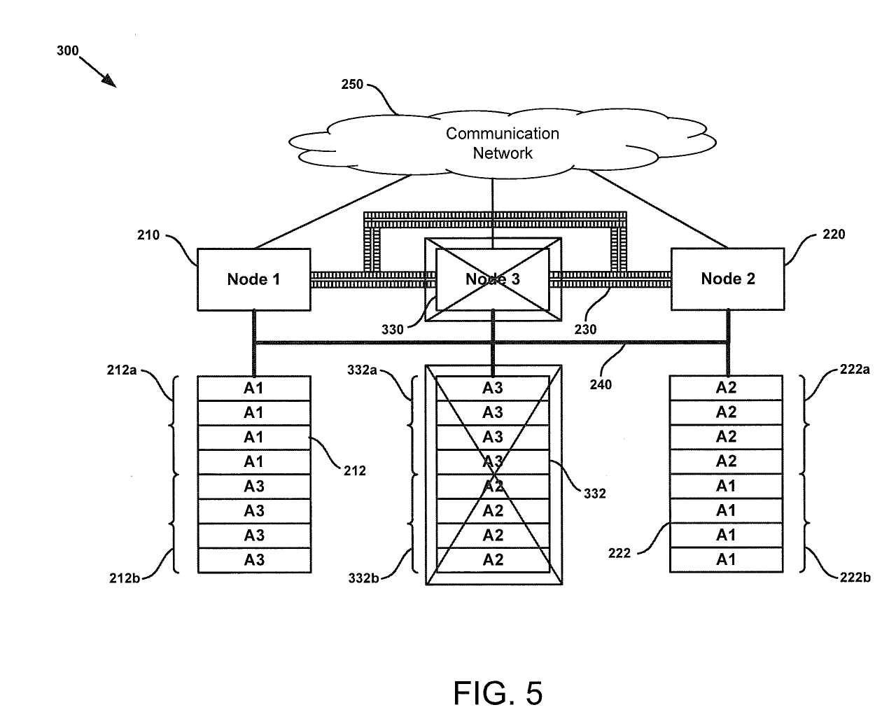

FIG. 5 is a block diagram illustrating a faulty node in a high availability storage network 300 in accordance with an aspect of the disclosure. For example, as shown in FIG. 5, node 330 has experienced a fault making node 330 inoperable. In general, a node may experience a fault making the node inoperable as a result of a failure in hardware, software, or a combination of hardware and software associated with the node. As a result of the failure of node 330, node 220 may have lost its mirror. In order to continue providing data services despite the inoperable node 330, a takeover routine may be implemented. Note that storage system 300 may be a high availability storage system. More specifically, prior to a fault being experienced and/or detected, storage unit 212 may store data A1 and mirrored data A3, storage unit 222 may store data A2 and mirrored data A1, and storage unit 332 may store data A3 and mirrored data A2.

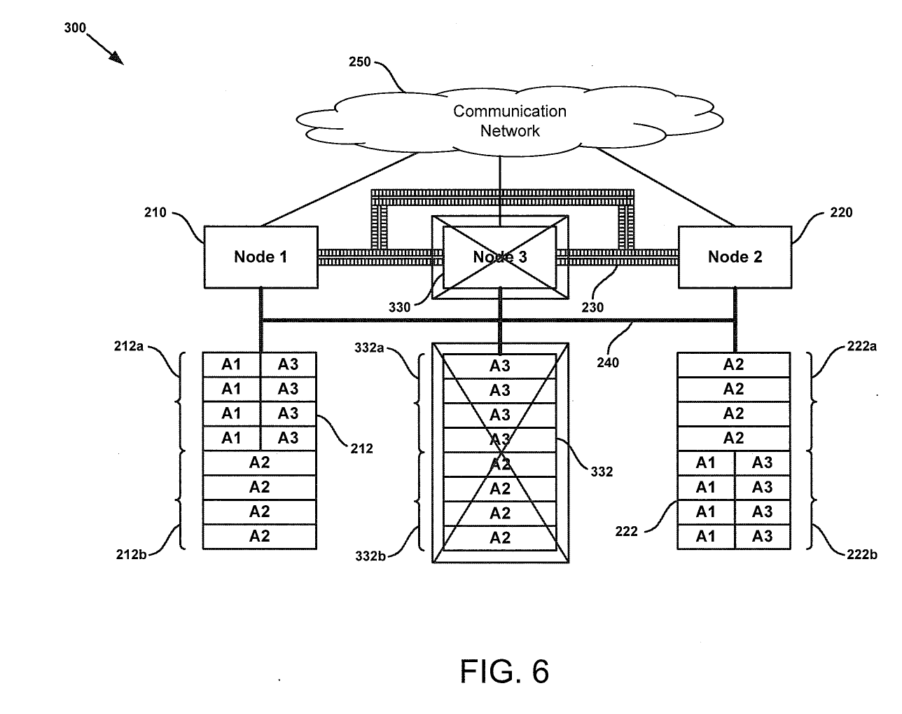

FIG. 6 is a block diagram illustrating a takeover routine and reallocation of data and mirrored data in the storage network to provide high availability in accordance with an aspect of the disclosure. It is appreciated that the takeover routine and reallocation of data may be implemented by one or more processing devices within network connected devices of storage system 100. For example, management console 150 may monitor and control the status of nodes and subsequent takeover/reallocation of data. Further, such actions may be implemented by one or more nodes 110 120. Additionally, resources between such devices may be shared in order to implement takeover/reallocation.

According to an aspect of the disclosure, the fault illustrated in storage system 300 associated with node 330 may be detected by another node in storage system 300, such as at least one of node 210 and/or node 220. In general, nodes in a storage network may be monitored by one or more nodes, management devices, and/or client devices in the storage network to detect a nonresponsive, inoperable, or faulty node. In response to detecting the fault, a takeover routine may be initiated. In some aspects of the disclosure, the takeover routine may be initiated manually or automatically. In one aspect of the disclosure, the takeover routine may be initiated by the node associated with the storage unit storing the mirrored data of the faulty node. For example, because the storage unit 212 is storing the mirrored data A3 associated with faulty node 330, as illustrated in FIG. 5, node 210 may initiate the takeover routine illustrated in FIG. 6. In other aspects of the disclosure, a node other than the node associated with the storage unit storing the mirrored data associated with the faulty node may initiate the takeover routine. After node 210 initiates the takeover routine, the takeover routine may be implemented to reallocate the data and mirrored data associated with node 210, node 220, and node 330 to storage unit 212 and storage unit 222.

According to one aspect of the disclosure, implementing the takeover routine illustrated in FIG. 6 may include allocating to storage unit 212 data A1, mirrored data A2, and mirrored data A3, and allocating to storage unit 222 data A2, mirrored data A1, and mirrored data A3. For example, as shown in the aspect of FIG. 6, storage container portion 212a may be further partitioned to store both data A1 and mirrored data A3, while storage container portion 212b may be allocated mirrored data A2. In addition, storage container portion 222a may be allocated data A2, while storage container portion 222b may be allocated mirrored data A1 and mirrored data A3.

In other aspects of the disclosure, a storage system may include a plurality of other operable nodes, and, after implementing the takeover routine, the data and mirrored data associated with, for example, node 210, node 220, and node 330 along with data and mirrored data associated with the plurality of other operable nodes may be balanced among storage unit 212, storage unit 222, and a plurality of other storage units associated with the plurality of other operable nodes in the storage system.

In general load balancing may be triggered manually or automatically after the takeover routine to balance the data associated with all the nodes in a storage system, including the faulty nodes, among the storage units associated with operable nodes. In some aspects of the disclosure, the node which initiated the takeover routine may also initiate the post takeover load balancing routine.

According to an aspect of the disclosure, the load balancing routine may include receiving, by the node that initiates the post takeover load balancing routine, information associated with the storage units in the storage system. For example, the received information may include information about which nodes are associated with or own a storage unit, and the information may be received from a database maintained in user space by clustering software.

The initiating node may then calculate the number of storage units to be served by each operable node in the storage system. In one aspect of the disclosure, the calculation may include dividing the total number of storage units by the number of operable nodes in the storage system to determine the number of storage units to be served by each node.

According to an aspect of the disclosure, the initiating node may then broadcast a request to reallocate X number of storage units, where X may be equate to the number of owned storage units minus the number of storage units to be served by each operable node in the storage system. When other nodes in the storage system receive the broadcast request, each node in the storage system may recompute the number of storage units to be served by each node and initiate a storage unit relocation request to acquire Y number of storage units from the initiating node, where Y may be the number of storage units to be served by each node minus the number of storage units owned by a node.

According to an aspect of the disclosure, the initiating node may oblige with the storage unit relocation request, thereby participating in the storage relocation routine. Further, the initiating node may participate in the storage unit relocation until the number of owned storage units is greater than the number of storage units per node.

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

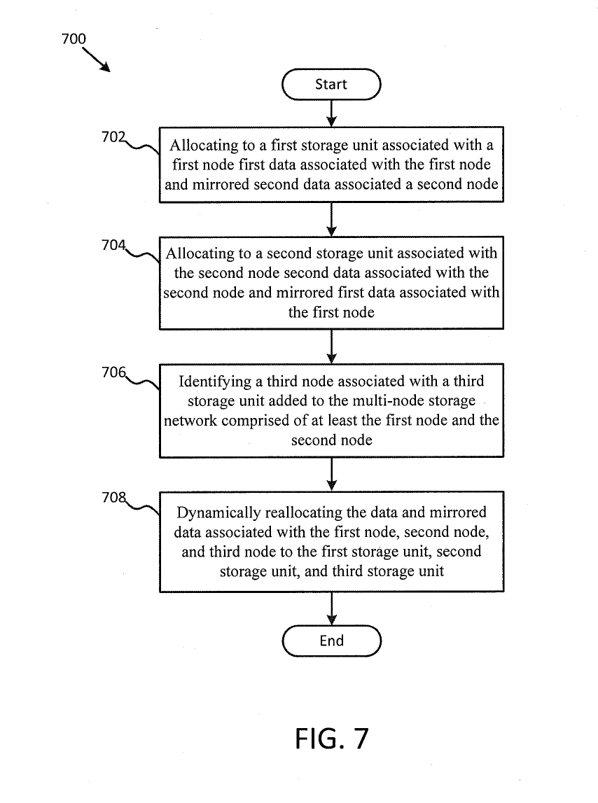

FIG. 7 illustrates a method 700 for increasing high availability of data in a multi-node storage network in accordance with an aspect of the disclosure. It is noted that aspects of method 700 may be implemented with the systems described above with respect to FIGS. 1-6. For example, aspects of method 700 may be implemented by one or more processing devices within network connected devices of storage system 100. For example, management console 150 may monitor and control the allocation and reallocation of data. Further, such actions may be implemented by one or more nodes 110 120. Additionally, resources between such devices may be shared in order to implement method 700.

Specifically, method 700 of the illustrated aspects includes, at block 702, allocating to a first storage unit associated with a first node first data associated with the first node and mirrored second data associated a second node. At block 704, method 700 also includes allocating to a second storage unit associated with the second node second data associated with the second node and mirrored first data associated with the first node. In some aspects of the disclosure, the aforementioned allocation disclosed at block 702 and block 704 may balance the data and mirrored data associated with the first node and the second node among the first storage unit and the second storage unit.

Method 700, as shown in FIG. 7, includes, at block 706, identifying a third node associated with a third storage unit added to the multi-node storage network comprised of at least the first node and the second node. At block 708, method 700 includes dynamically reallocating the data and mirrored data to rebalance the data and/or mirrored data associated with the first node, second node, and third node among the first storage unit, second storage unit, and third storage unit.

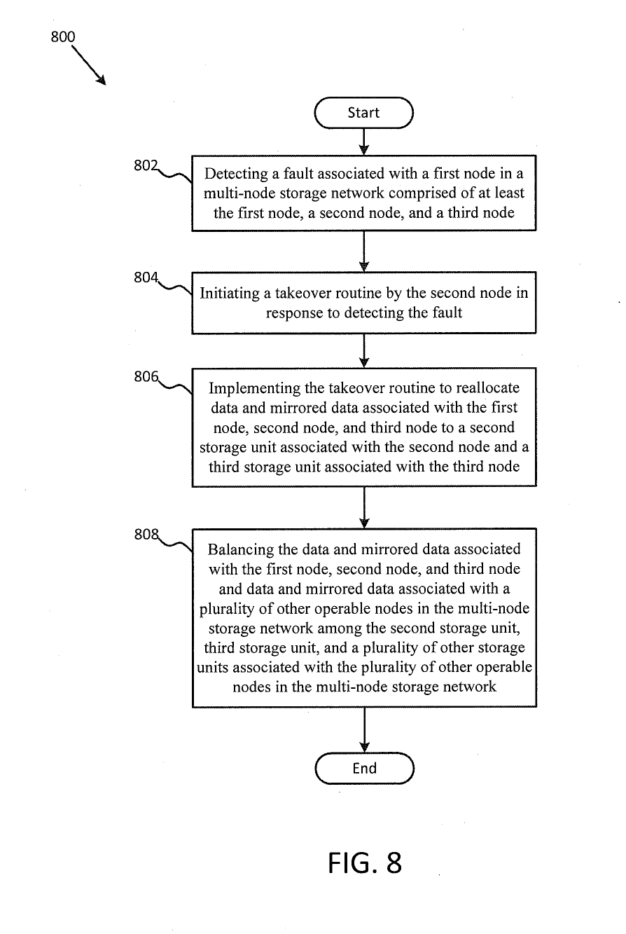

FIG. 8 illustrates a method 800 for high availability takeover in a multi-node storage network in accordance with an aspect of the disclosure. It is noted that aspects of method 800 may be implemented with the systems described above with respect to FIGS. 1-6. For example, aspects of method 800 may be implemented by one or more processing devices within network connected devices of storage system 100. For example, management console 150 may monitor and control the allocation and reallocation of data. Further, such actions may be implemented by one or more nodes 110 120. Additionally, resources between such devices may be shared in order to implement method 800. Specifically, method 800, at block 802, includes detecting a fault associated with a first node in a multi-node storage network comprised of at least the first node, a second node, and a third node. At block 804, method 800 includes initiating a takeover routine by the second node in response to detecting the fault. In addition, method 800 includes, at block 806, implementing the takeover routine to reallocate data and mirrored data associated with the first node, second node, and third node to a second storage unit associated with the second node and a third storage unit associated with the third node.

Method 800 also includes, at block 808, balancing, after implementing the takeover routine, the data and mirrored data associated with the first node, second node, and third node and data and mirrored data associated with a plurality of other operable nodes in the multi-node storage network among the second storage unit, third storage unit, and a plurality of other storage units associated with the plurality of other operable nodes in the multi-node storage network

The circular-chained high availability relationship with a neighboring node disclosed herein allows for both scale-out and dynamic relocation of high availability relationships in the event of a node failure without impacting other nodes in the cluster. Further, the aspects of the disclosure disclosed herein may also be cost effective as a single node can be added at a time without compromising high availability for any of the nodes in the cluster. In theory, this disclosure may provide resiliency of (N−1) nodes in a cluster.

The schematic flow chart diagrams of FIGS. 7-8 are generally set forth as logical flow chart diagrams. As such, the depicted order and labeled steps are indicative of one aspect of the disclosed method. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. Although various arrow types and line types may be employed in the flow chart diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular methods occurs may or may not strictly adhere to the order of the corresponding steps shown.

Some aspects of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some aspects of the disclosure may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some aspects of the disclosure include a computer program product comprising a computer-readable medium (media) having instructions stored thereon/in and, when executed (e.g., by a processor), perform methods, techniques, or aspects described herein, the computer readable medium comprising sets of instructions for performing various steps of the methods, techniques, or aspects of the disclosure described herein. The computer readable medium may comprise a storage medium having instructions stored thereon/in which may be used to control, or cause, a computer to perform any of the processes of an aspect of the disclosure. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some aspects of the disclosure different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some aspects of the disclosure include software instructions for controlling both the hardware of the general purpose or specialized computer or microprocessor, and for enabling the computer or microprocessor to interact with a human user and/or other mechanism using the results of an aspect of the disclosure. Such software may include without limitation device drivers, operating systems, and user applications. Ultimately, such computer readable media further includes software instructions for performing aspects of the disclosure described herein. Included in the programming (software) of the general-purpose/specialized computer or microprocessor are software modules for implementing some aspects of the disclosure.

Those of skill would further appreciate that the various illustrative logical blocks, modules, circuits, and algorithm steps described in connection with the disclosure herein may be implemented as electronic hardware, computer software stored on a computing device and executed by one or more processing devices, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the aspects of the disclosure disclosed herein may be implemented or performed with a processor module, such as a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. For example, in some aspects of the disclosure, each node in a multi-node storage network, such as nodes 210, 220, and 330 may include a processor module to perform the functions described herein. In other aspects of the disclosure, a management device may also include a processor module to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the aspects disclosed herein may be embodied directly in hardware, in software executed by a processor, or in a combination of the two. In some aspects of the disclosure, any software module, software layer, or thread described herein may comprise an engine comprising firmware or software and hardware configured to perform aspects of the described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the aspects of the disclosure described herein have been described with reference to numerous specific details, one of ordinary skill in the art will recognize that the aspects of the disclosure can be embodied in other specific forms without departing from the spirit of the aspects of the disclosure. Thus, one of ordinary skill in the art would understand that the aspects described herein are not to be limited by the foregoing illustrative details, but rather are to be defined by the appended claims.

It is also appreciated that the systems and method described herein are able to be scaled for larger storage network systems. For example, a cluster may include hundreds of nodes, multiple virtual servers which service multiple clients, and the like. Such modifications may function according to the principles described herein.

Although the subject matter and its advantages have been described in detail, it should be understood that various changes, substitutions and alterations can be made herein without departing from the spirit and scope of the subject matter as defined by the appended claims. Moreover, the scope of the disclosure is not intended to be limited to the particular aspects of the process, machine, manufacture, composition of matter, means, methods and steps described in the specification. As one of ordinary skill in the art will readily appreciate from the disclosure of the subject matter, processes, machines, manufacture, compositions of matter, means, methods, or steps, presently existing or later to be developed that perform substantially the same function or achieve substantially the same result as the corresponding aspects described herein may be utilized according to the subject matter. Accordingly, the appended claims are intended to include within their scope such processes, machines, manufacture, compositions of matter, means, methods, or steps.

What is claimed is:

1. A method for increasing high availability of data in a multi-node storage network, the method comprising:
dynamically reallocating, by at least one processor module in the storage network, data which has been allocated to a first storage unit associated with a first node that includes first data associated with the first node and mirrored second data associated with a second node, and data which has been allocated to a second storage unit associated with the second node which includes second data associated with the second node and mirrored first data associated with the first node, to rebalance at least one of the mirrored first data and mirrored second data by allocating to a third storage unit associated with a third node at least one of the mirrored first data and mirrored second data and allocating mirrored third data associated with the third node onto at least one of the first and second storage units.

2. The method of claim 1, further comprising:
allocating, by the at least one processor module of the storage network, to the first storage unit the first data and the mirrored second data; and
allocating, by the at least one processor module of the storage network, to the second storage unit the second data and the mirrored first data,
wherein the data and mirrored data associated with the first node and the second node is balanced among the first storage unit and the second storage unit.

3. The method of claim 1, further comprising:
identifying, by the at least one processor module of the storage network, the third node added to a multi-node storage network comprised of at least the first node and the second node by receiving, by at least one of the first node and the second node, a notification from the third node indicating its addition to the storage network.

4. The method of claim 1, wherein dynamically reallocating comprises:
allocating, by the at least one processor module of the storage network, to the third storage unit third data associated with the third node and the mirrored second data;
allocating, by the at least one processor module of the storage network, to the first storage unit the first data and the mirrored third data; and
allocating, by the at least one processor module of the storage network, to the second storage unit the second data and the mirrored first data.

5. The method of claim 4, further comprising:
detecting, by the at least one processor module of the storage network, a fault associated with the first node;
initiating, by the at least one processor module of the storage network, a takeover routine by the second node in response to detecting the fault; and
implementing, by the at least one processor module of the storage network, the takeover routine to reallocate data and mirrored data associated with the first node, second node, and third node to the second storage unit and the third storage unit.

6. The method of claim 5, wherein implementing the takeover routine comprises:
allocating, by the at least one processor module of the storage network, to the second storage unit the second data, the mirrored first data, and the mirrored third data; and
allocating, by the at least one processor module of the storage network, to the third storage unit the third data, the mirrored first data, and the mirrored second data.

7. The method of claim 5, further comprising:
balancing, by the at least one processor module of the storage network, after implementing the takeover routine, the data and mirrored data associated with the first node, second node, and third node and data and mirrored data associated with a plurality of other operable nodes in the multi-node storage network among the second storage unit, third storage unit, and a plurality of other storage units associated with the plurality of other operable nodes in the multi-node storage network.

8. A network device comprising:
a memory containing machine readable medium comprising machine executable code having stored thereon instructions for performing a method for increasing high availability of data in a multi-node storage network comprising at least a first storage unit associated with a first node and a second storage unit associated with a second node; and
a processer module coupled to the memory, the processor module configured to execute the machine executable code to:
dynamically reallocate data which has been allocated to the first storage unit that includes first data associated with the first node and mirrored second data associated with the second node, and data which has been allocated to the second storage unit which includes second data associated with the second node and mirrored first data associated with the first node, to rebalance at least one of the mirrored first data and mirrored second data by allocating to a third storage unit associated with a third node at least one of the mirrored first data and mirrored second data and allocating mirrored third data associated with the third node onto at least one of the first and second storage units.

9. The network device of claim 8, wherein the processor module is further configured to execute the machine executable code to:
allocate to the first storage unit the first data and the mirrored second data; and
allocate to the second storage unit the second data and the mirrored first data,
wherein the data and mirrored data associated with the first node and the second node is balanced among the first storage unit and the second storage unit.

10. The network device of claim 8, wherein the processor module is further configured to execute the machine executable code to:
identify the third node added to the multi-node storage network by receiving, by at least one of the first node and the second node, a notification from the third node indicating its addition to the storage network.

11. The network device of claim 8, wherein the processor module configured to execute the machine executable code to dynamically reallocate data and mirrored data comprises the processor module being further configured to execute the machine executable code to:
allocate to the third storage unit third data associated with the third node and the mirrored second data;
allocate to the first storage unit the first data and the mirrored third data; and
allocate to the second storage unit the second data and the mirrored first data.

12. The network device of claim 11, wherein the processor module is further configured to execute the machine executable code to:
detect a fault associated with the first node;
initiate a takeover routine by the second node in response to detecting the fault; and
implement the takeover routine to reallocate data and mirrored data associated with the first node, second node, and third node to the second storage unit and the third storage unit.

13. The network device of claim 12, wherein the processor module configured to execute the machine executable code to implement the takeover routine comprises the processor module being further configured to execute the machine executable code to:
allocate to the second storage unit the second data, the mirrored first data, and the mirrored third data; and
allocate to the third storage unit the third data, the mirrored first data, and the mirrored second data.

14. The network device of claim 12, wherein the processor module is further configured to execute the machine executable code to:
balance, after implementing the takeover routine, the data and mirrored data associated with the first node, second node, and third node and data and mirrored data associated with a plurality of other operable nodes in the multi-node storage network among the second storage unit, third storage unit, and a plurality of other storage units associated with the plurality of other operable nodes in the multi-node storage network.

15. A non-transitory machine readable medium having stored thereon instructions for performing a method for increasing high availability of data in a multi-node storage network comprising at least a first storage unit associated with a first node and a second storage unit associated with a second node, comprising machine executable code which when executed by at least one machine causes the machine to:
dynamically reallocate data which has been allocated to the first storage unit that includes first data associated with the first node and mirrored second data associated with the second node, and data which has been allocated to the second storage unit which includes second data associated with the second node and mirrored first data associated with the first node, to rebalance at least one of the mirrored first data and mirrored second data by allocating to a third storage unit associated with a third node at least one of the mirrored first data and mirrored second data and allocating mirrored third data associated with the third node onto at least one of the first and second storage units.

16. The non-transitory machine readable medium of claim 15, further comprising machine executable code causing the machine to:
allocate to the first storage unit the first data and the mirrored second data; and
allocate to the second storage unit the second data and the mirrored first data,
wherein the data and mirrored data associated with the first node and the second node is balanced among the first storage unit and the second storage unit.

17. The non-transitory machine readable medium of claim 15, further comprising machine executable code causing the machine to:
identify the third node added to the multi-node storage network by receiving, by at least one of the first node and the second node, a notification from the third node indicating its addition to the storage network.

18. The non-transitory machine readable medium of claim 15, further comprising machine executable code causing the machine to:
detect a fault associated with the first node;
initiate a takeover routine by the second node in response to detecting the fault; and
implement the takeover routine to reallocate data and mirrored data associated with the first node, second node, and third node to the second storage unit and the third storage unit.

19. The non-transitory machine readable medium of claim 19, wherein the machine executable code causing the machine to implement the takeover routine comprises machine executable code causing the machine to:
allocate to the second storage unit the second data, the mirrored first data, and the mirrored third data; and
allocate to the third storage unit the third data, the mirrored first data, and the mirrored second data.

20. The non-transitory machine readable medium of claim 19, further comprising machine executable code causing the machine to:
balance, after implementing the takeover routine, the data and mirrored data associated with the first node, second node, and third node and data and mirrored data associated with a plurality of other operable nodes in the multi-node storage network among the second storage unit, third storage unit, and a plurality of other storage units associated with the plurality of other operable nodes in the multi-node storage network.
